(19) United States
(12) Patent Application Publication
(10) Pub. No.: US 2018/0152649 A1
(43) Pub. Date: May 31, 2018

(54) IMAGE PROCESSING APPARATUS, IMAGE PICKUP APPARATUS, IMAGE PROCESSING METHOD, AND STORAGE MEDIUM

(71) Applicant: CANON KABUSHIKI KAISHA, Tokyo (JP)

(72) Inventors: Yuichi Kusumi, Utsunomiya-shi (JP); Chiaki Inoue, Utsunomiya-shi (JP); Yoshiaki Ida, Utsunomiya-shi (JP)

(21) Appl. No.: 15/815,830

(22) Filed: Nov. 17, 2017

(30) Foreign Application Priority Data
Nov. 30, 2016 (JP) 2016-232006

(51) Int. Cl. H04N 5/357

(52) U.S. Cl. CPC H04N 5/357

(57) ABSTRACT

An image processing apparatus includes a diffuse image obtainer configured to obtain a diffuse reflection image by using an input image, and a processor configured to perform noise reduction processing for the diffuse reflection image by using specular reflection information in the input image.

### BACKGROUND OF THE INVENTION

### Field of the Invention

The present invention relates to an image processing apparatus, an image pickup apparatus, an image processing method, and a storage medium.

### Description of the Related Art

A variety of images can be generated in image processing after an image is captured by separating an input image into a diffuse (reflection) component and a specular (reflection) component. For example, a gloss sense controlled image can be generated by using a diffuse reflection component and a specular reflection component as a gloss component.

It is necessary to highly precisely obtain a surface normal so as to generate an image with a different object light condition. An object view depends on object shape information, object reflectance information, light source information, etc. Since a physical behavior of reflected light that is made when light emitted from a light source is reflected on the object depends on a local surface normal, it is particularly effective to use the surface normal of the object as the shape information rather than a three-dimensional shape. A photometric stereo method is used as a method for acquiring the surface normal of the object. Since the photometric stereo method obtains a surface normal on the assumption that the object follows the Lambertian diffuse reflection, only the diffuse reflection component is necessary in the input image. Hence, a technology of estimating the diffuse reflection component based on the input image is necessary. Once the diffuse reflection component is estimated based on the input image, the specular reflection component can be simultaneously obtained by subtracting the diffuse reflection component from the input image.

Japanese Patent Laid-Open No. 2013-65215 and Tomoaki Higo, Daisuke Miyazaki, and Katsushi Ikeuchi, “Realtime Removal of Specular Reflection Component Based on Dichromatic Reflection Model,” The Special Interest Group Technical Reports of Information Processing Society of Japan, Computer Vision and Image Media, pp. 211-218 (2006) utilize that the object follows the dichromatic reflection model, and disclose a method that obtains a diffuse reflection image from the input image based on a pixel extracted for each hue in the input image. In the dichromatic reflection model, the reflected light from the object can be expressed as a linear sum of the diffuse reflection component as an object color and the specular reflection component as a light source color.

However, where the input image contains noises, the obtained diffuse reflection image has residue noises. In particular, in the obtained diffuse reflection image, the residue noises may stand out in an area in which the specular reflection exists in the input image. The specular reflection area in the input image has a luminance value higher than that in the diffuse reflection area, and thus has more noises. Therefore, in acquiring the diffuse reflection image, the SN ratio lowers and the residue noises stand out in the area in which the specular reflection exists in the input image. The above prior art references do not consider the residue noises in the diffuse reflection image obtained from the input image.

### SUMMARY OF THE INVENTION

The present invention provides an image processing apparatus, an image pickup apparatus, an image processing method, and a storage medium, which can obtain diffuse reflection image having reduced residue noises.

An image processing apparatus according to one aspect of the present invention includes a diffuse image obtainer configured to obtain a diffuse reflection image by using an input image, and a processor configured to perform noise reduction processing for the diffuse reflection image by using specular reflection information in the input image.

An image processing apparatus according to another aspect of the present invention includes a processor configured to perform noise reduction processing for an input image based on at least specular reflection information in the input image, and a diffuse image obtainer configured to obtain a diffuse reflection image based on the input image after the noise reduction processing.

Further features of the present invention will become apparent from the following description of exemplary embodiments with reference to the attached drawings.

### BRIEF DESCRIPTION OF THE DRAWINGS

FIG. 1 is a block diagram of an image pickup apparatus according to first and second embodiments.

FIG. 2 is a flowchart of an image processing method according to the first embodiment.

FIG. 3 is a schematic view of a flow for acquiring a diffuse reflection image based on an input image.

FIG. 4 illustrates a diffuse reflection component and a specular reflection component in a saturation-intensity plane.

FIG. 5 illustrates an estimation of the diffuse reflection component.

FIG. 6 illustrates a specular reflection area.

FIG. 7 is a flowchart of an image processing method according to the second embodiment.

### DESCRIPTION OF THE EMBODIMENTS

Referring now to the accompanying drawings, a detailed description will be given of embodiments of the present invention. The same elements in each figure will be designated by the same reference numerals, and a duplicate description will be omitted.

### First Embodiment

This embodiment describes a method for acquiring a diffuse (reflection) image based on an input image, and for acquiring a diffuse reflection image in which residue noises are reduced through noise reduction processing to the diffuse reflection image.

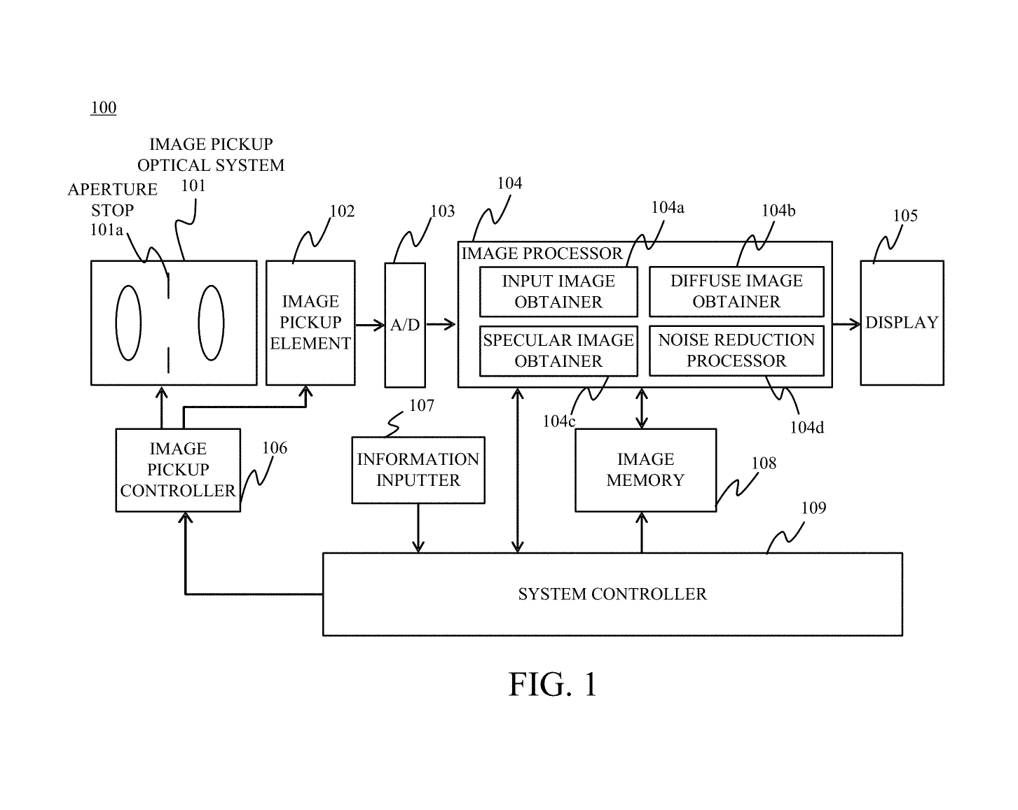

FIG. 1 is a block diagram of an image pickup apparatus 100. An image pickup optical system 101 includes an aperture (stop) 101a, and images light from an object on an image pickup element 102. The image pickup element 102 includes a photoelectric conversion element, such as a CCD sensor and a CMOS sensor, and images the object. An analog electric signal generated by a photoelectric conversion by the image pickup element 102 is converted into a digital signal by an A/D converter 103 and input into an image processor 104. The image pickup optical system 101 may be built in the image pickup apparatus 100 or may be detachably attached to the image pickup apparatus 100, such as a single-lens reflex camera.

An image processor 104 performs general image processing available to the digital signal, and obtains a diffuse reflection image in which residue noises are reduced, based on the input image. The image processor 104 includes an input image obtainer 104a, a diffuse image obtainer 104b, a specular image obtainer 104c, and a noise reduction processor 104d. The diffuse image obtainer 104b obtains a diffuse reflection image based on the input image. The specular image obtainer 104c obtains a specular (reflection) image based on the input image. The noise reduction processor 104d performs noise reduction processing for the diffuse reflection image.

An output image processed by the image processor 104 is stored in an image memory 108, such as a semiconductor memory and an optical disc. The output image may be displayed on the display 105.

The input image obtainer 104a, the diffuse image obtainer 104b, the specular image obtainer 104c, and the noise reduction processor 104d are installed in the image pickup apparatus 100 in this embodiment, but these components may be configured as an image processing apparatus separate from the image pickup apparatus.

An information inputter 107 supplies an image pickup condition selected by a user, such as an F-number, an exposure time period, and a focal length, to a system controller 109. An image pickup controller 106 obtains an image under the desired image pickup condition selected by the user, based on the information from the system controller 109.

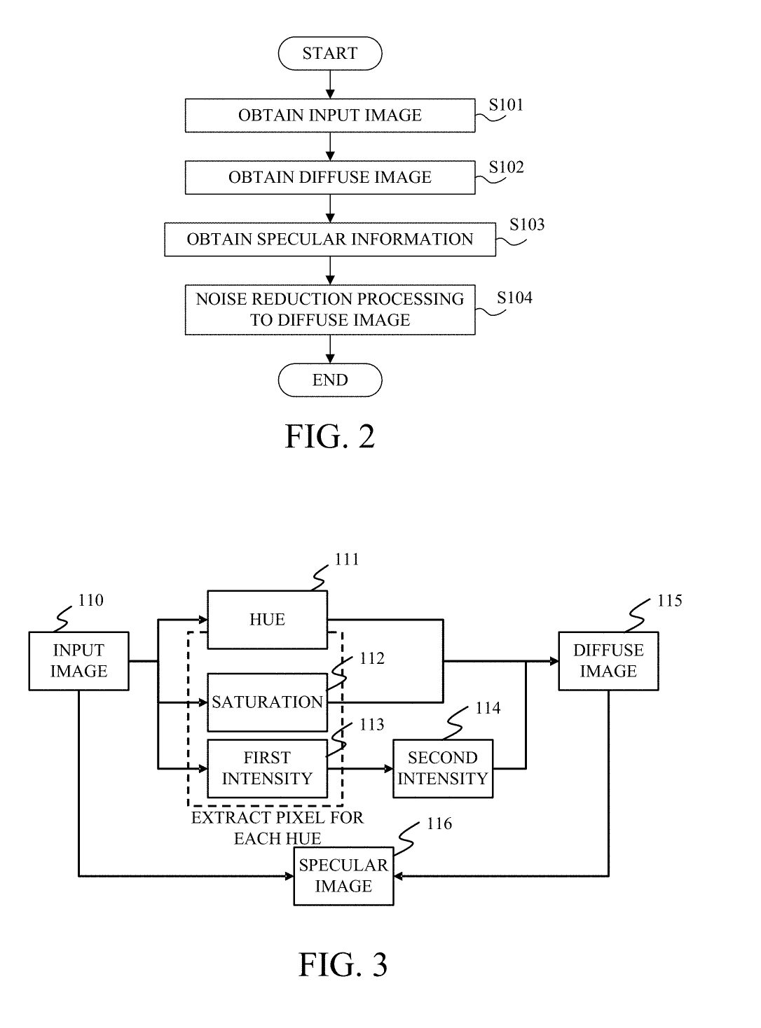

FIG. 2 is a flowchart of an image processing method according to this embodiment. The system controller 109 and the image processor 104 execute the image processing method of this embodiment in accordance with an image processing program as a computer program. The image processing program may be recorded, for example, in a computer-readable storage medium.

In the step S101, the input image obtainer 104a obtains a captured image as an input image from the image pickup apparatus 100. The input image obtainer 104a may obtain as the input image an image that is made by performing the noise reduction processing for the captured image. Where the image processor 104 is configured as an image processing apparatus separate from the image pickup apparatus, the input image may be obtained via a wireless or wired communication with the image pickup apparatus or may be obtained through a storage medium, such as a semiconductor memory and an optical disc.

In the step S102, the diffuse image obtainer 104b obtains the diffuse reflection image based on the input image. Referring now to FIG. 3, a description will be given of a method for acquiring the diffuse reflection image based on the input image. FIG. 3 is a schematic view of a flow for acquiring the diffuse reflection image based on the input image. This embodiment obtains the diffuse reflection image 115 based on the input image 110 using a method that uses a dichromatic reflection model disclosed in the above two prior art references. This method extracts a pixel from the input image 110 for each hue 111 in the input image 110 so as to estimate the diffuse reflection component for each object as the same diffuse reflectance. Where the light source is white, the hue 111 in the input image 110 depends only on the diffuse reflection component and is irrelevant with whether the specular reflection component exists. Thus, the pixel can be extracted only from the object with the same diffuse reflectance by using the hue 111. Hence, the input image 110 may be previously made as an image under the white light source by the white balance correction.

Initially, the diffuse image obtainer 104b extracts a plurality of pixels from the input image 110 for each hue 111 in the input image 110. The hue is calculated based on the following expressions (1) and (2). Herein, r, g, and b represent RGB values in the image for which the hue is calculated.

$$\begin{matrix}( \begin{matrix}{I}_{x} \\ {I}_{y} \\ {I}_{z}\end{matrix} ) = ( \begin{matrix}1 & - \frac{1}{2} & - \frac{1}{2} \\ 0 & \frac{\sqrt{3}}{2} & - \frac{\sqrt{3}}{2} \\ \frac{1}{3} & \frac{1}{3} & \frac{1}{3}\end{matrix} ) ( \begin{matrix}r \\ g \\ b\end{matrix} ) & ( 1 ) \\ hue = arctan \frac{{I}_{x}}{{I}_{y}} & ( 2 )\end{matrix}$$

The hue is calculated by the following expression (3) using the expressions (1) and (2).

$$hue = arctan ( \frac{\frac{\sqrt{3}}{2} g - \frac{\sqrt{3}}{2} b}{r - \frac{1}{2} g - \frac{1}{2} b} ) \qquad ( 3 )$$

This step extracts a pixel from the input image 110 for each hue 111 based on the hue 111 in the input image 110 but may set a range for a hue of the pixel to be extracted.

Next, the diffuse image obtainer 104b estimates the diffuse reflection component in the input image 110 based on the pixel extracted from the input image 110 for each hue 111 in the input image 110.

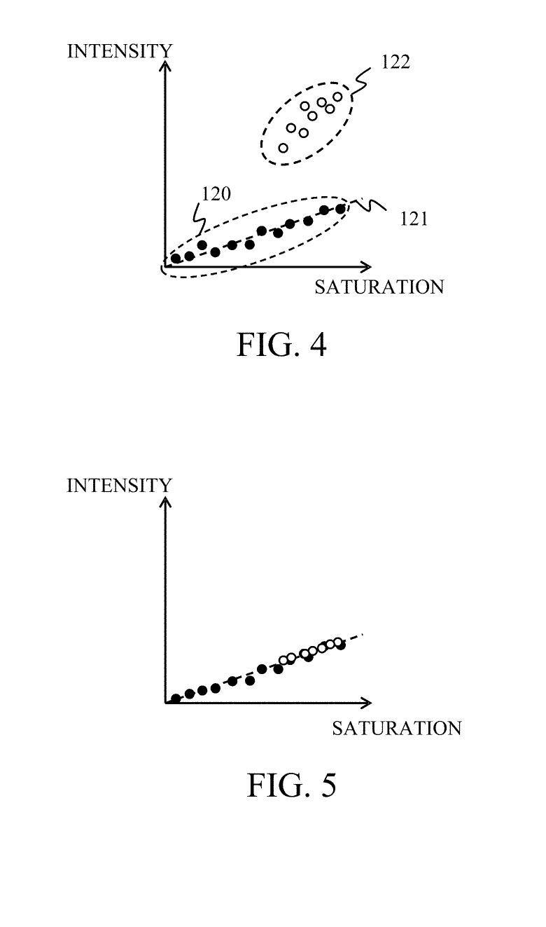

FIG. 4 illustrates a diffuse reflection component and a specular reflection component in the saturation-intensity plane. The abscissa axis denotes a saturation calculated in the following expression (4). The ordinate axis denotes an intensity calculated in the following expression (5). In FIG. 4, a pixel extracted with a predetermined hue among the hue 111 in the input image 110 are plotted based on the saturation and the intensity. The diffuse reflection component 120 exists on a line 121 that passes the origin. Where the light source is white, a component 122 in which the specular reflection is added to the diffuse reflection component 120 exists while the saturation does not change and only the intensity changes in comparison with the diffuse reflection component 120.

saturation=\sqrt{Iₓ²+I_{y}²} (4)

intensity=I_{z}² (5)

This embodiment obtains the hue 112 and the intensity 113 (first intensity) in the pixel extracted from the input image 110 for each hue 111 in the input image 110, and estimates a slope of the line 121 with the diffuse reflection component 120.

The slope of the line 121 may be estimated with a variety of fitting methods. The estimation of the slope of the line 121 needs only the diffuse reflection component 120 but the component 122 that contains the specular reflection component is an unnecessary wrong value and thus the fitting method may be preferable so as to avoid the wrong value. In order to remove the component 122 that contains the specular reflection, the slope of the line 121 may be estimated based only on the pixel of the first intensity 113 that is minimum in each saturation.

The line 121 calculated based on the estimated slope or the pixel having the first intensity 113 that is higher than the intensity of the diffuse reflection component 120 (diffuse reflection intensity) can be regarded as the component 122 that contains the specular reflection. By replacing the first intensity 113 in this pixel with the second intensity 114 on the line 121 as illustrated in FIG. 5, the specular reflection component can be obtained from which the specular reflection component is removed. Alternatively, the first intensity 113 in all pixels is replaced with the second intensity 114 as the diffuse reflection intensity illustrated by the line 121.

The estimated slope of the line 121 is a parameter determined by the object diffuse reflectance and different for each object. Thus, the diffuse reflection component is obtained for each object classified by the hue by extracting the pixel for each hue in the object and by calculating the slope of the line 121.

In addition, where the light source is white, the saturation does not change and only the intensity changes in the component 122 that contains the specular reflection in comparison with the diffuse reflection component 120. Thus, the input image 110 may be set to an image under the white light source due to the white balance correction.

Next, the diffuse image obtainer 104b obtains the diffuse reflection image 115 based on the second intensity 114, the saturation 112, and the hue 111 in the obtained diffuse reflection component. The diffuse reflection image 115 can be calculated by inversely converting the expressions (1) to (5).

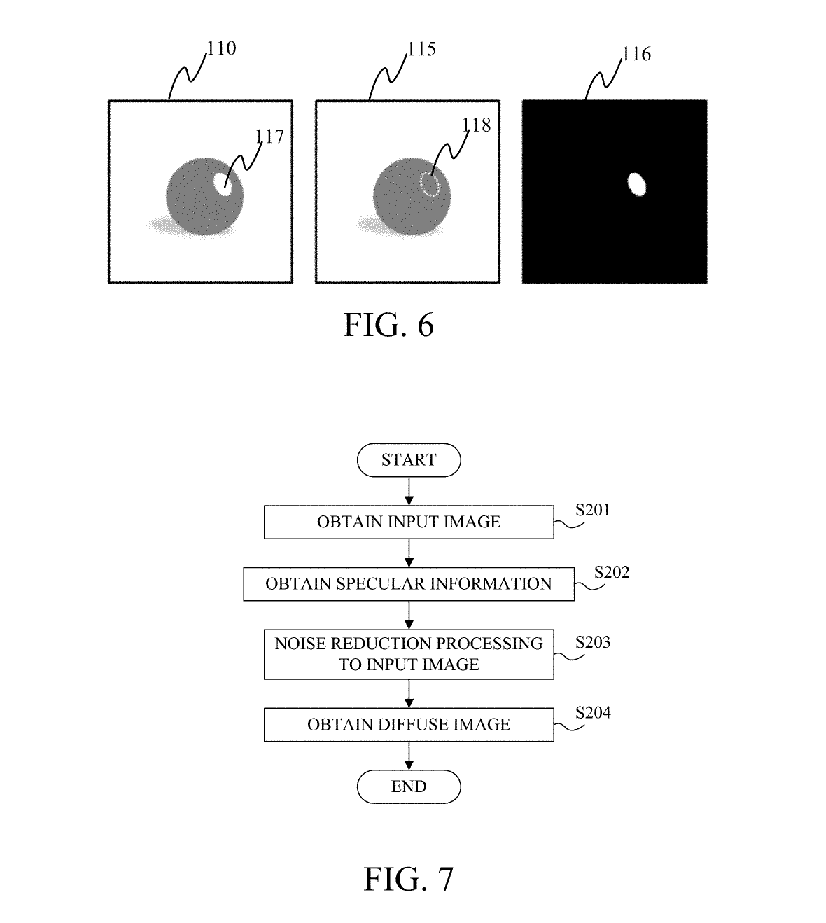

The diffuse reflection image 115 can be obtained by removing the specular reflection component from the input image 110, as illustrated in FIG. 6. A specular reflection area 117 in the input image 110 has a luminance value higher than that in the diffuse area, and thus more noises. Hence, an area 118 that contains the specular reflection in the input image 110 in the diffuse reflection image 115 has residue noises, and thus a low SN ratio. In other words, the residue noises may stand out in the diffuse reflection image 115.

In the step S103, the specular image obtainer 104c obtains the specular reflection information from the input image 110 obtained in the step S101. While this embodiment obtains the specular reflection image 116 as the specular reflection information, the present invention is not limited to this embodiment. For example, the specular reflection area may be set to the area having a luminance value of a predetermined value or higher in the input image 110 or the image used to extract the specular area may be set to the specular reflection image. Alternatively, the specular reflection area may be manually selected or the specular reflection area may be set by classifying the specular reflection information. The specular reflection image 116 can be obtained by subtracting the diffuse reflection image 115 obtained in the step S102 from the input image 110.

In the step S104, the noise reduction processor 104d performs noise reduction processing for the diffuse reflection image 115 obtained in the step S102 based on the specular reflection information obtained in the step S103. This processing enables the noise reduction processor 104d to acquire the diffuse reflection image 115 having the reduced residue noises. As described above, since the specular reflection area 117 in the input image 110 has a luminance value higher than that of the diffuse area and more noises, the SN ratio lowers in the area 118 having the specular reflections in the input image 110 in the diffuse reflection image 115 from which the specular reflection component has been removed. Thus, the noise reduction processing may be performed for the area 118 in the diffuse reflection image 115. According to this embodiment, the noise reduction processor 104d performs the noise reduction processing for the area 118 in the diffuse reflection image 115 by using the specular reflection image 116 as the specular reflection information. The noise reduction processing may use a variety of methods.

More specifically, the noise reduction processor 104d determines the effect of the noise reduction processing based on the luminance value of the specular reflection image 116. For example, since the area having a higher luminance value of the specular reflection image 116 has more noises, the noise reduction processing is intensified. In addition, the area of the noise reduction processing may be determined based on the luminance value of the specular reflection image 116. For example, the noise reduction processing may be performed only for the area having a luminance value higher than the predetermined threshold in the specular reflection image 116.

Moreover, the noise reduction processing may be performed based on the specular reflection image 116 and the diffuse reflection image 115. An area with the specular reflection image 116 having a higher luminance image and the diffuse reflection image 115 having a lower luminance has a lower SN ratio in the area 118 having the specular reflection in the input image 110 in the diffuse reflection image 115. Hence, the effect of the noise reduction processing may be determined based on a difference and a ratio among the luminance values in the specular reflection image 116 and the diffuse reflection image 115.

As described above, this embodiment can obtain the diffuse reflection image having reduced residue noises from the input image based on the specular reflection information.

The image pickup apparatus and the image processing apparatus according to this embodiment may include a gloss controller configured to control gloss in the image through the weighting addition of the diffuse reflection image and the specular reflection image having the reduced residue noises that have been obtained in the step S104. Since the gloss sense of the image depends on the specular reflection component, the image having the controlled gloss can be obtained by changing a rate of the specular reflection image to be added to the obtained diffuse reflection image. The rate of the specular reflection image to be added may be set to a preset ratio or may be arbitrarily determined as a gloss sense by a user. In addition, the gloss controller may control the gloss in the image by the weighting subtraction of the input image and the specular reflection image. In other words, the gloss sense of the image may be controlled by changing a rate of the specular reflection image to be subtracted from the input image. The specular reflection image used for the gloss control may use an image that is made by subtracting the diffuse reflection image having the reduced residue noises obtained in the step S104 from the input image.

### Second Embodiment

In this embodiment, a description will be given of a method for performing noise reduction processing for an input image and for acquiring a diffuse reflection image having reduced residue noises from the input image that has experienced the noise reduction processing.

Even this embodiment performs image processing using the image pickup apparatus 100 illustrated in FIG. 1 similar to the first embodiment, but the noise reduction processor 104d performs noise reduction processing for the input image. Other configurations are the same as those in the first embodiment, and a detailed description will be omitted.

FIG. 7 is a flowchart of an image processing method according to this embodiment. The system controller 109 and the image processor 104 execute the image processing method of this embodiment in accordance with an image processing program as a computer program. The image processing program may be recorded, for example, in a computer-readable storage medium.

In the step S201, the input image obtainer 104a obtains as the input image 110 the captured image from the image pickup apparatus 100.

In the step S202, the specular image obtainer 104c obtains the specular reflection information from the input image 110 obtained in the step S201. This embodiment obtains the specular reflection image 116 as the specular reflection information, but the present invention is not limited to this embodiment. For example, the specular reflection information may be set to the area having a predetermined luminance value of the input image 110 or the specular reflection area may be set to the image used to extract the specular reflection area. Alternatively, the specular reflection area may be manually selected or the specular reflection area may be set by classifying the specular reflection information. The specular reflection image 116 can be obtained by similar processes to those in the steps S102 and S103 in FIG. 2 in the first embodiment, and thus a detailed description thereof will be omitted.

In the step S203, the noise reduction processor 104d performs the noise reduction processing for the input image 110 obtained in the step S201 based on the specular reflection information obtained in the step S202. Due to this processing, the noise reduction processor 104d can obtain the input image 110 having reduced residue noises. As described above, since the specular reflection area 117 in the input image 110 has a luminance value higher than that in the diffuse reflection area and more noises, the SN ratio reduces in the area 118 having the specular reflection in the input image 110 in the diffuse reflection image 115 from which the specular reflection component has been removed. Hence, the noise reduction processing may be performed for the specular reflection area 117 in the input image 110. In this embodiment, the noise reduction processing 104d uses the specular reflection image 116 as the specular reflection area, and can perform the noise reduction processing for the specular reflection area 117 in the input image 110.

In the step S204, the diffuse image obtainer 104b obtains the diffuse reflection image 115 from the input image 110 after the noise reduction process obtained in the step S203. Since the diffuse reflection image 115 can be obtained through a process similar to that in the step S102 in FIG. 2 descried in the first embodiment, a detailed description thereof will be omitted.

As described above, this embodiment can obtain diffuse reflection image having reduced residue noises based on the input image in which the noise reduction processing has been performed based on the specular reflection information.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-232006, filed Nov. 30, 2016, which is hereby incorporated by reference herein in its entirety.

What is claimed is:

1. An image processing apparatus comprising:
a diffuse image obtainer configured to obtain a diffuse reflection image by using an input image; and
a processor configured to perform noise reduction processing for the diffuse reflection image by using specular reflection information in the input image.

2. The image processing apparatus according to claim 1, wherein the diffuse image obtainer extracts a plurality of pixels from the input image by using a hue in the input image, and estimates the diffuse reflection image by using the plurality of pixels that have been extracted.

3. The image processing apparatus according to claim 1, wherein the processor determines an intensity of the noise reduction processing by using the specular reflection information.

4. The image processing apparatus according to claim 3, wherein the processor sets a higher intensity of the noise reduction processing as a luminance value in the specular reflection information is higher.

5. The image processing apparatus according to claim 1, wherein the processor determines an area for the noise reduction processing by using the specular reflection information.

6. The image processing apparatus according to claim 5, wherein the processor performs the noise reduction processing in an area having a luminance value higher than a threshold in the specular reflection information.

7. The image processing apparatus according to claim 1, further comprising a specular image obtainer configured to obtain a specular reflection image by using the input image,
wherein the processor performs the noise reduction processing by using the specular reflection image.

8. The image processing apparatus according to claim 7, wherein the specular image obtainer obtains the specular reflection image by subtracting the diffuse reflection image from the input image.

9. The image processing apparatus according to claim 7, wherein the processor performs the noise reduction processing based on the diffuse reflection image and the specular reflection image.

10. An image processing apparatus comprising:
a processor configured to perform noise reduction processing for an input image by using specular reflection information in the input image; and
a diffuse image obtainer configured to obtain a diffuse reflection image by using the input image after the noise reduction processing.

11. The image processing apparatus according to claim 10, wherein the diffuse image obtainer extracts a plurality of pixels from the input image by using a hue in the input image, and estimates the diffuse reflection image by using the plurality of pixels that have been extracted.

12. The image processing apparatus according to claim 10, wherein the processor determines an intensity of the noise reduction processing by using the specular reflection information.

13. The image processing apparatus according to claim 12, wherein the processor sets a higher intensity of the noise reduction processing as a luminance value in the specular reflection information is higher.

14. The image processing apparatus according to claim 10, wherein the processor determines an area for the noise reduction processing by using the specular reflection information.

15. The image processing apparatus according to claim 14, wherein the processor performs the noise reduction processing in an area having a luminance value higher than a threshold in the specular reflection information.

16. The image processing apparatus according to claim 10, further comprising a specular image obtainer configured to obtain a specular reflection image by using the input image,
wherein the processor performs the noise reduction processing by using the specular reflection image.

17. An image pickup apparatus comprising:
an image pickup element configured to capture an object; and
an image processing apparatus according to claim 1.

18. An image pickup apparatus comprising:
an image pickup element configured to capture an object; and
an image processing apparatus according to claim 10.

19. An image processing method comprising the steps of:
obtaining a diffuse reflection image by using an input image; and
performing noise reduction processing for the diffuse reflection image by using specular reflection information in the input image.

20. A non-transitory computer-readable storage medium configured to store a computer program that enables a computer to execute an image processing method according to claim 19.
